(19) United States
(12) Patent Application Publication
(10) Pub. No.: US 2011/0226095 A1
(43) Pub. Date: Sep. 22, 2011

(54) NAIL POSITIONING DEVICE

(75) Inventor: Ying-Chien Chen, TAICHUNG COUNTY (TW)

(73) Assignee: LUCKY-BRAND INDUSTRIAL CO., LTD., TAICHUNG COUNTY (TW)

(21) Appl. No.: 12/780,819

(22) Filed: May 14, 2010

(30) Foreign Application Priority Data
Mar. 22, 2010 (TW) 099108431

(51) Int. Cl. B25C 3/00

(52) U.S. Cl. 81/44

(57) ABSTRACT

A nail positioning device includes a base member having a plurality of nail positioning notches for holding different sizes of nails in vertical for hammering into a workpiece by a hammer, and a nail punch installed in the base member for attaching to the head of a nail being partially driven into the workpiece for enabling the nail to be completely driven into the workpiece positively and accurately without damaging the workpiece.

### BACKGROUND OF THE INVENTION

1. Field of the Invention

The present invention relates to a nail positioning tools and more particularly, to a nail positioning device, which is attached with a nail punch and practical for use to hold any of a variety of nails of different sizes in vertical, for enabling the nail to be accurately driven into the workpiece by a hammer.

2. Description of the Related Art

Referring to FIG. 1, a conventional nail positioning device 10 comprises a rod member 12 curbed at an angle, and a grip 14 sleeved onto one part of the rod member 12. The rod member 12 has a nail positioning groove 124 located on an end face 122 thereof. The nail positioning groove 124 extends vertically through a top plane 126 and a bottom pane 128 that are located on the top and bottom sides of the rod member 12 and respectively extended from the top and bottom edges of the end face 122 at right angles. When using a hammer to drive a nail into a workpiece, attach the nail to the nail positioning groove 124 to keep the head and point of the nail respectively spaced above the top plane 126 and below the bottom pane 128 at a distance, and then hold the grip 14 of the nail positioning device 10 with one hand to keep the nail in the nailing position and operate the hammer with the other hand to drive the nail into the workpiece. Thus, the user needs not to hold the nail by hand and can drive the nail into the workpiece conveniently, avoiding any accidental finger injury during nailing.

In order to hold any nail within a predetermined range of diameters, the nail positioning groove 124 is made having a certain width and the periphery of the nail positioning groove 124 is made magnetically attractive. Thus, a relatively smaller diameter nail can be secured to the nail positioning groove 124 in vertical. However, when a nail having a diameter smaller than the width of the nail positioning groove 124 is attached to the nail positioning groove 124, the nail may be not kept in vertical and may be biased during nailing, causing the nail to be driven into the workpiece in a wrong or oblique position. In this case, the nail positioning device 10 loses its function.

Further, the rod member 12 of the aforesaid prior art nail positioning device 10 has a certain length so that the user's hand can be kept away from the nailing position at a distance, avoiding accidental injury. Thus, a major part of the nail positioning device 10 is used for holding by hand, wasting much useful space. Designing a supplementary tool within this useful space can enhance the functioning of the nail positioning device, increasing its value.

Therefore, it is desirable to provide a nail positioning device, which eliminates the drawbacks of the aforesaid prior art design.

### SUMMARY OF THE INVENTION

The present invention has been accomplished under the circumstances in view. It is the main object of the present invention to provide a nail positioning device, which is practical for holding any of a variety of different sizes of nails in vertical for nailing.

It is another object of the present invention to provide a nail positioning device, which is equipped with a nail punch to assist nailing.

To achieve these and other objects of the present invention, a nail positioning device comprises a base member and a nail punch. The base member has a top surface, a bottom surface opposing the top surface, a first end portion, and a plurality of nail positioning notches spaced on the end edge of the first end portion and cut through the top surface and the bottom surface for holding nails of different diameters. Each nail positioning notch has an opening at the end edge of the first end portion. The nail punch is installed in the base member, having a pressure-receiving face and a pressure-output face opposing the pressure-receiving face. When nailing a nail into an object, the user can attach insert the nail into one suitable nail positioning notch and then hold the nail positioning device with one hand to keep the nail vertically in the nailing position and then operate a hammer to drive the nail into the object positively and accurately. Further, after the nail has been driven into the object to a certain depth, the user can attach the pressure-output face of the nail punch to the head of the nail and then strike the hammer against the pressure-receiving face of the nail punch to drive the nail into the object further, forcing the head of the nail into the surface of the object without damaging the object.

Other and further benefits, advantages and features of the present invention will be understood by reference to the following specification in conjunction with the accompanying drawings, in which like reference signs denote like elements of the structure.

### BRIEF DESCRIPTION OF THE DRAWINGS

FIG. 1 is an elevational view of a nail positioning device according to the prior art.

FIG. 2 is an elevational view of a nail positioning device in accordance with a first embodiment of the present invention.

FIG. 3 is a top plain view of the nail positioning device in accordance with the first embodiment of the present invention.

FIG. 4 is a front view of the nail positioning device in accordance with the first embodiment of the present invention.

FIG. 5 shows an application example of the nail positioning device in accordance with the first embodiment of the present invention.

FIG. 6 shows another application example of the nail positioning device in accordance with the first embodiment of the present invention.

FIG. 7 is a top view of a nail positioning device in accordance with a second embodiment of the present invention.

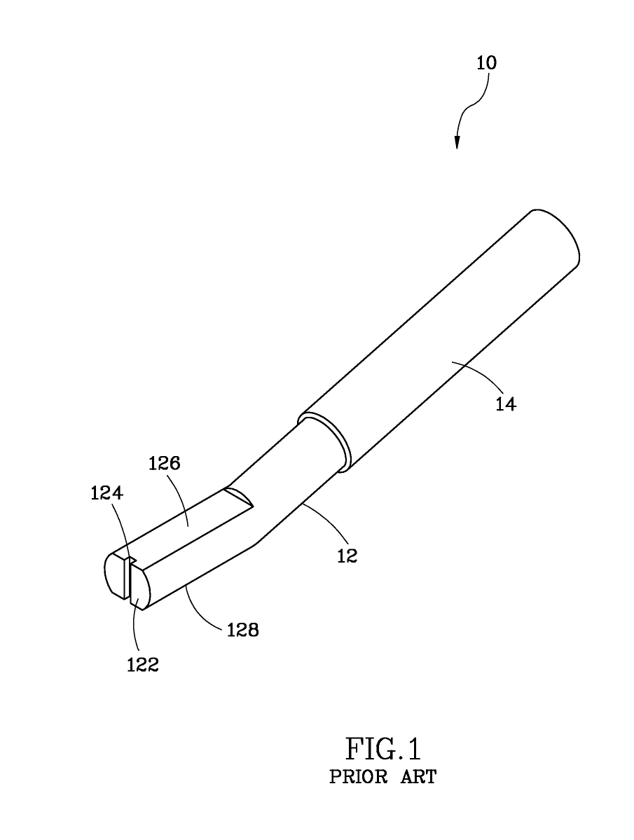

### DETAILED DESCRIPTION OF THE INVENTION

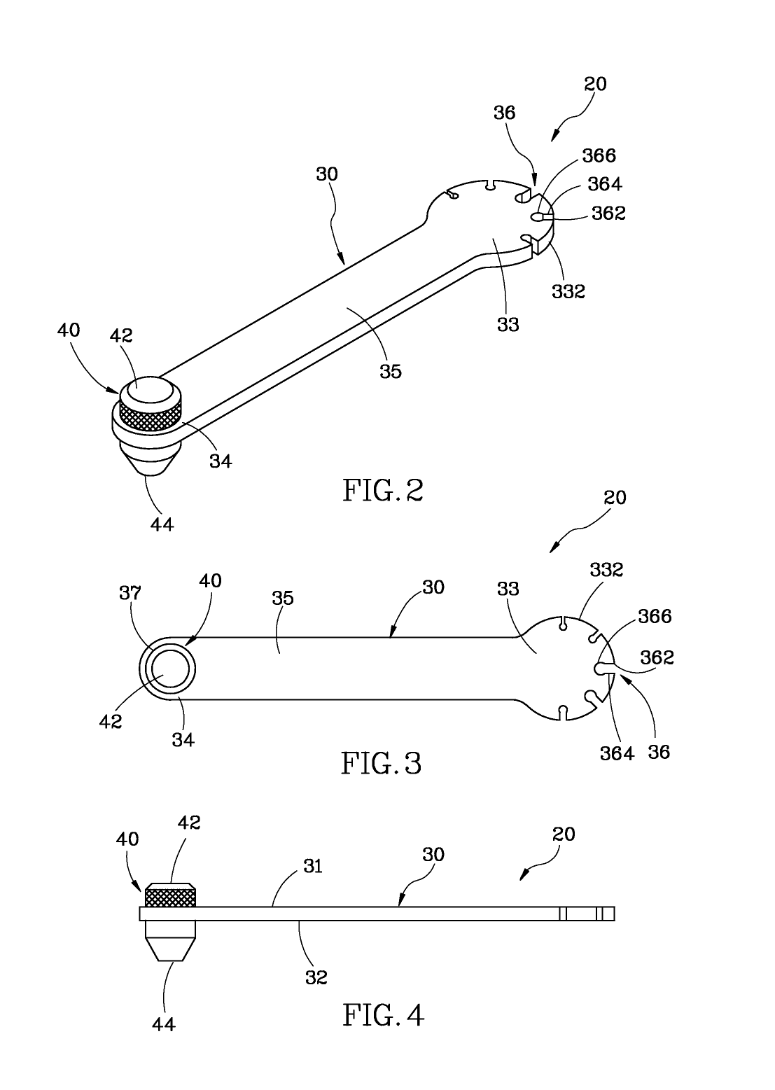

Referring to FIGS. 2˜4, a nail positioning device 20 in accordance with a first embodiment of the present invention is shown comprising a base member 30 and a nail punch 40.

The base member 30 is a narrow elongated flat bar, having opposing top surface 31 and bottom surface 32. When viewing in direction from the top surface 31 toward the bottom surface 32, the base member 30 is divided into a first end portion 33, a second end portion 34 and a body portion 35 connected between the first end portion 33 and the second end portion 34. The first end portion 33 has a circular shape. The diameter of the first end portion 33 is greater than the width of the body portion 35. The first end portion 33 has five nail positioning notches 36 cut through the top surface 31 and the bottom surface 32 and equally spaced around the border. Each nail positioning notch 36 has an opening 362 located on the end edge 332 of the first end portion 33, a passage 364 extended from the opening 362 toward the inside of the base member 30 and a round hole 366 connected to the end of the passage 364 remote from the opening 362. The round holes 366 of the five nail positioning notches 36 have different diameters for the insertion of nails having different diameters. The width of the passage 364 of each nail positioning notch 36 is smaller than the diameter of the associating round hole 366 so that the nail that is inserted through the round hole 366 of one nail positioning notch 36 will not pass out of the round hole 366 through the associating passage 364 easily. Further, the second end portion 34 of the base member 30 has a through hole 37 cut through the top surface 31 and the bottom surface 32.

The nail punch 40 is made of a metal material and processed through a special hardening treatment and shaped like a cylindrical rod member, however the two distal ends thereof are tapered and gradually reducing in reversed directions away from each other. Thus, one end of the nail punch 40 terminates in a pressure-receiving end face 42, and the other end of the nail punch 40 terminates in a pressure-output end face 44. The cross section of the pressure-receiving end face 42 is slightly smaller than the cross section of the middle part of the nail punch 40. The cross section of the pressure-output end face 44 is smaller than that of the pressure-receiving end face 42. The nail punch 40 is fixedly mounted in the through hole 37 of the base member 30 in such a manner that the pressure-receiving end face 42 suspends above the elevation of the top surface 31 and the pressure-output end face 44 suspends below the elevation of the bottom surface 32.

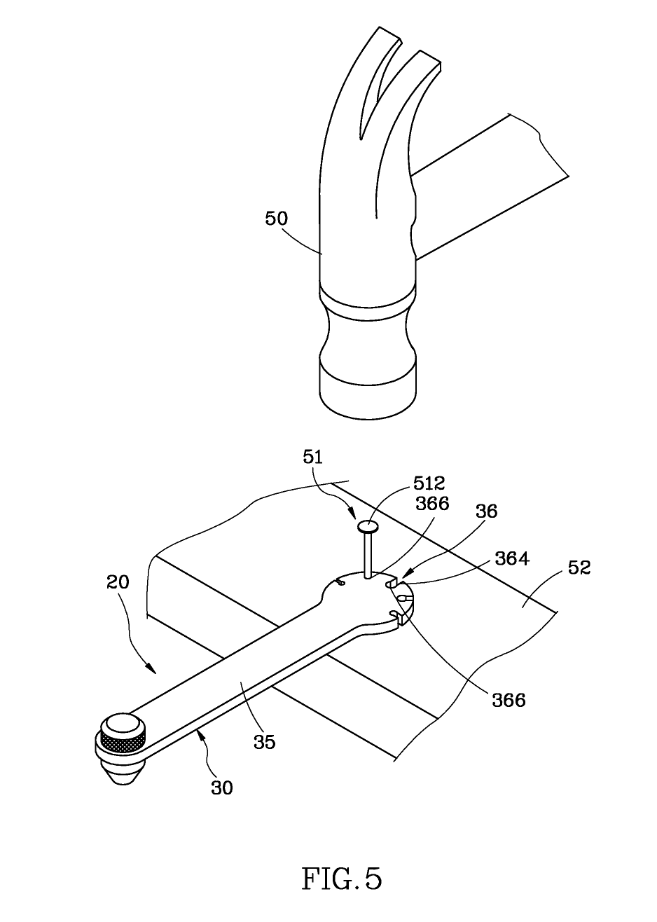

FIG. 5 shows an application example of the nail positioning device 20. As illustrated, when using a hammer 50 to drive a nail 51 into an object 52 (for example, a wood plate or wood wall), the nail 51 must be held firmly in vertical at the selected location. At this time, the user can insert the nail 51 into the round hole 366 of one nail positioning notch 36 of the nail positioning device 20, enabling the nail 51 to be held in vertical by the nail positioning device 20 and aimed at the selected location. At this time, the user can hold the nail positioning device 20 with one hand and operate the hammer 50 with the other hand to drive the nail 51 into the object 52 accurately in the desired position. After the nail 51 has been driven into the object 52 to a certain depth, the user can move the nail positioning device 20 relative to the nail 51, for enabling the nail 51 to pass through the associating passage 364 and then to separate from the nail positioning device 20.

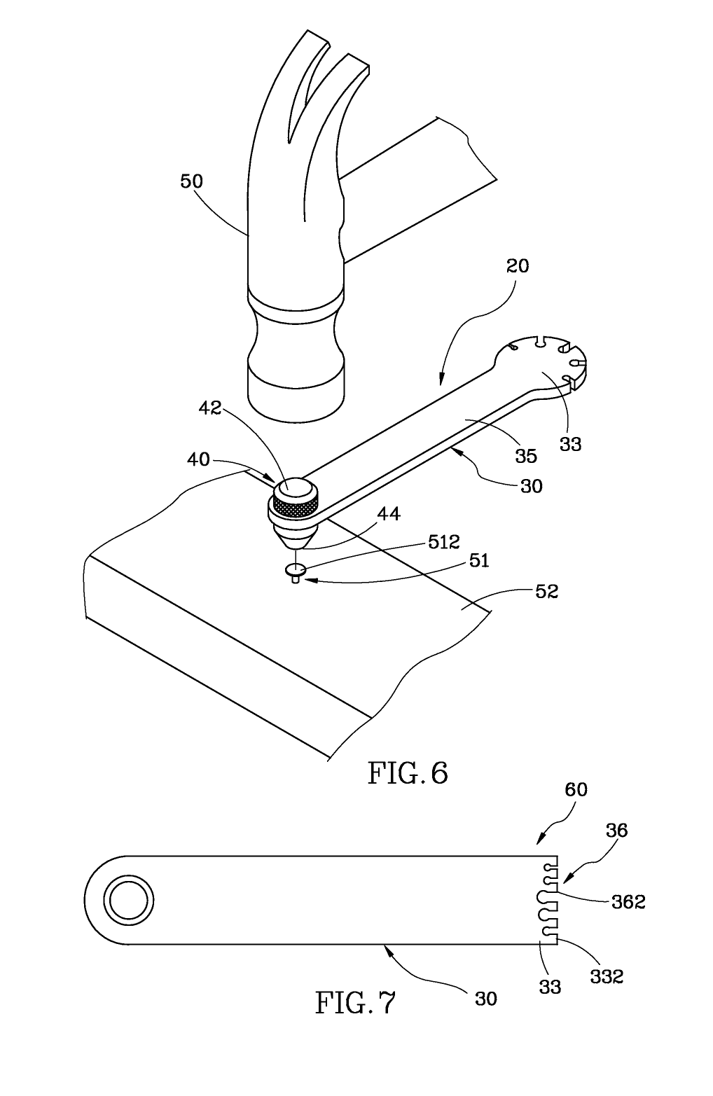

FIG. 6 shows another application example of the nail positioning device 20. As illustrated, after the nail 51 has been driven into the object 52 to a certain depth and removal of the nail positioning device 20 from the nail 51, the user can hold the body portion 35 or first end portion 33 of the nail positioning device 20 with one hand and attach the pressure-output end face 44 of the nail punch 40 to the head 512 of the nail 51 and operate the hammer 50 to hit the pressure-receiving end face 42 of the nail punch 40, driving the nail 51 into the object 52 till that the head 512 of the nail 51 has been completely merged into the inside of the object 52. Subject to the use of the nail positioning device 20, the nail 51 can be accurately driven into the object 52, avoiding damage to the object 52 during hammering.

According to the aforesaid first embodiment of the present invention, the round holes 366 of the nail positioning notches 36 of the nail positioning device 20 have different diameters for holding different sizes of nails. Thus, this single nail positioning device 20 can be used to assist installation of different sizes of nails. Further, one same nail positioning device 20 provides an extra nail punching function, enhancing the value of the tool.

However, it is to be understood that the base member 30 of the nail positioning device 20 is not limited to the shape of the aforesaid narrow elongated flat bar. The base member 30 can be made in any of a variety of shapes convenient for enabling the user to hold the nail positioning device 20 with one hand and to keep the hand away from the hammering position at a certain distance, and with an end edge 332 provided for the formation of the openings 362 of the designed nail positioning notches 36. Further, the end edge 332 of the first end portion 33 is not limited to the arched shape. For example, FIG. 7 illustrates a nail positioning device 60 in accordance with a second embodiment of the present invention. According to this second embodiment, the base member 30 of the nail positioning device 60 is shaped like a flat rectangular bar. The first end portion 33 of the base member 30 that carries the nail positioning notches 36 has a flat end edge 332, and the openings 362 of the nail positioning notches 36 are located on the flat end edge 332. Thus, this second embodiment achieves the same effects as the aforesaid first embodiment of the present invention.

Further, a magnet (not shown) may be set inside the first end portion 33 of the base member 30 of the nail positioning device 20 or 60 so that a magnetic attractive force is provided at the periphery of the round hole 366 of each nail positioning notch 36. Alternatively the periphery of the round hole 366 of each nail positioning notch 36 may be directly coated with a layer of magnetic material. Thus, when a ferrous nail is inserted into the round hole 366 of one nail positioning notch 36, it is secured to the round hole 366 in place by magnetic attraction.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A nail positioning device, comprising:
a base member having opposing top surface and bottom surface, said base member comprising a first end portion, a plurality of nail positioning notches cut through said top surface and said bottom surface, each said nail positioning notch having an opening on an end edge of said first end portion; and
a nail punch affixed to said base member remote from said first end portion, said nail punch having a pressure-receiving end face and a pressure-output end face opposing said pressure-receiving end face.

2. The nail positioning device as claimed in claim 1, wherein each said nail positioning notch comprises a passage extending from the opening thereof toward the inside of said base member and a round hole located on one end of said passage remote from the opening; the round holes of said nail positioning notches have different diameters.

3. The nail positioning device as claimed in claim 1, wherein the end edge of said first end portion has an arched shape.

4. The nail positioning device as claimed in claim 1, wherein the end edge of said first end portion has a flat shape.

5. The nail positioning device as claimed in claim 1, wherein said base member further comprises a second end portion opposing said first end portion; said nail punch is located on said second end portion.

6. The nail positioning device as claimed in claim 5, wherein said nail punch extends through said second end portion, holding said pressure-receiving end face above the elevation of said top surface and said pressure-output end face below the elevation of said bottom surface.

7. The nail positioning device as claimed in claim 6, wherein each said nail positioning notch comprises a passage extending from the opening thereof toward the inside of said base member and a round hole located on one end of said passage remote from the opening; the round holes of said nail positioning notches have different diameters.

8. The nail positioning device as claimed in claim 7, wherein the end edge of said first end portion has an arched shape.

9. The nail positioning device as claimed in claim 7, wherein the end edge of said first end portion has a flat shape.

10. The nail positioning device as claimed in claim 1, wherein said first end portion provides a magnetic attractive force.
